(19) United States
(12) Patent Application Publication
(10) Pub. No.: US 2025/0109228 A1
(43) Pub. Date: Apr. 3, 2025

(54) SILICONE IMPACT MODIFIERS USING A ONE-STEP PROCESS

(71) Applicant: Rohm and Haas Company, Collegeville, PA (US)

(72) Inventors: Pu Luo, King Of Prussia, PA (US); Morris Wills, Philadelphia, PA (US)

(21) Appl. No.: 18/717,469

(22) PCT Filed: Dec. 15, 2022
(86) PCT No.: PCT/US2022/052918

§ 371 Date: Jun. 7, 2024

Related U.S. Application Data
(63) Continuation of application No. 63/290,675, filed on Dec. 17, 2021.

(51) Int. Cl. C08F 230/08; C08F 2/01; C08F 2/26

(52) U.S. Cl. CPC C08F 230/085; C08F 2/01; C08F 2/26; C08F 2400/02

(57) ABSTRACT

A one-step process for preparing a silicone impact modifier comprises polymerizing a reaction mixture, where the reaction mixture comprises a telechelic methacrylate functional silicone and at least one alkyl (meth)acrylate.

### FIELD OF THE INVENTION

This invention relates generally to one-step processes for producing silicone impact modifiers.

### BACKGROUND

Silicone acrylic core-shell-rubber (CSR) impact modifiers are often used in a variety of thermoplastics, including polycarbonate (PC). These impact modifiers often have a crosslinked silicone core with a grafted methyl methacrylate (MMA) shell. These silicone acrylic CSR impact modifiers are typically prepared by a two-step polymerization process in which the silicone rubber stage is polymerization of silanes or silicones and the shell step is a free radical process prepared by conventional emulsion polymerization.

Alternatively, U.S. Patent Application Publication No. 2021/0317247 discloses the use of telechelic (α, ω) methacrylate functional linear polydimethylsiloxane (PDMS). The telechelic methacrylate functional silicone cannot be prepared by conventional emulsion polymerization due to the negligible water solubility of the material. Therefore, to prepare a latex particle via free radical polymerization of the methacrylate end groups of the telechelic methacrylate functional silicone, mini-emulsion polymerization was employed. Mini-emulsion polymerization involves the direct polymerization of latex size droplets (100-500 nm). In the process disclosed by U.S. Patent Application Publication No. 2021/0317247, a two-step polymerization process was required to synthesis a silicone acrylic core shell rubber. In the first step, the telechelic methacrylate functional silicone had to be diluted with butyl acrylate (BA) monomer to prepare the first rubber stage of the impact modifier by mini-emulsion. In the second step, the methyl methacrylate (MMA) shell was prepared in conventional emulsion polymerization. Due to the required dilution of the telechelic methacrylate functional silicone in the first step, high silicone loadings are not possible with the two-step polymerization process.

There is a need to develop new processes for preparing silicone acrylic impact modifiers.

### SUMMARY OF THE INVENTION

One aspect of the invention provides a process for preparing a silicone impact modifier. The process comprising polymerizing a reaction mixture, where the reaction mixture comprising a telechelic methacrylate functional silicone and at least one alkyl (meth)acrylate.

### BRIEF DESCRIPTION OF THE DRAWINGS

FIG. 1 is a graph comparing the impact performance of a silicone acrylic impact modifier prepared according to the process of the invention with commercially available impact modifiers and a silicone acrylic impact modifier prepared according to the process of the comparative example.

### DETAILED DESCRIPTION

The inventors have surprisingly found that a silicone core acrylic shell impact modifier can be prepared in a one-step process.

As used herein, the term “polymer” refers to a polymeric compound prepared by polymerizing monomers, whether of the same or a different type. The generic term “polymer” includes the terms “homopolymer,” “copolymer,” “terpolymer,” and “resin.” As used herein, the term “polymerized units derived from” refers to polymer molecules that are synthesized according to polymerization techniques wherein a product polymer contains “polymerized units derived from” the constituent monomers which are the starting materials for the polymerization reactions. As used herein, the term “(meth)acrylate” refers to either acrylate or methacrylate or combinations thereof, and the term “(meth)acrylic” refers to either acrylic or methacrylic or combinations thereof. As used herein, the term “substituted” refers to having at least one attached chemical group, for example, alkyl group, alkenyl group, vinyl group, hydroxyl group, carboxylic acid group, other functional groups, and combinations thereof.

As used herein, the term “multistage polymer” refers to a polymer that is made by forming (i.e., polymerizing) a first polymer, called the “first stage” or the “first stage polymer,” which forms the core of the multistage polymer. Then, in the presence of the first stage, forming a second polymer called the “second stage” or “second stage polymer, which can be an intermediate stage or the final stage of the multistage polymer. The multistage polymer may comprise additional stages, which may be formed before or after the second stage polymer. Each intermediate stage is formed in the presence of the polymer resulting from the polymerization of the stage immediately previous to that intermediate stage. In such embodiments wherein each subsequent stage forms a partial or complete shell around each of the particles remaining from the previous stage, the multistage polymer that results is known as a “core/shell” polymer, where the first stage polymer comprises the core and each subsequent stage comprises a shell on the preceding stage with the final stage forming the outermost shell. Thus, the second stage polymer will comprise at least part of the shell in the multistage polymer.

Previously known processes for preparing silicone acrylic impact modifiers required a multistage process in which a silicone polymer or a silicone acrylic co-polymer was first prepared, followed by a subsequent step in which an acrylic shell was polymerized onto the silicone core.

As used herein, the term “weight average molecular weight” or “Mw” refers to the weight average molecular weight of a polymer as measured by gel permeation chromatography (“GPC”), for acrylic polymers against polystyrene calibration standards following ASTM D5296-11 (2011), and using tetrahydrofuran (“THF”) as the mobile phase and diluent. As used herein, the term “weight of polymer” means the dry weight of the polymer.

The process according to the present invention is a one-step process in which a reaction mixture comprising a telechelic methacrylate functional silicone and at least one alkyl (meth)acrylate is polymerized. Without wishing to be bound by theory, it is believed that the acrylic polymer, e.g., poly(methyl methacrylate) (PMMA) when the at least one alkyl (meth)acrylate is methyl methacrylate, which is formed in the polymerization reaction phase separates from the silicone even though the acrylic polymer and silicone are covalently bound to one another between the end groups of the silicone and the at least one alkyl (meth)acrylate, and further, that the acrylic polymer preferentially forms the shell due to the more hydrophilic nature of the alkyl (meth)acrylate and the more hydrophobic nature of the silicone. This has been experimentally observed by atomic force microscopy (AFM) in which the silicone and PMMA phases are clearly distinguished.

The telechelic methacrylate functional silicone is preferably a compound of formula:

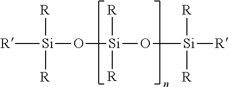

where each R is independently hydrogen or a hydrocarbon group; n is 0 to 1; and every R′ is independently an organic group that contains one or more ethylenically unsaturated group.

Preferred R groups are hydrogen and hydrocarbon groups having 12 or fewer carbon atoms; more preferably hydrogen and hydrocarbon groups having 8 or fewer carbon atoms; more preferably hydrocarbon groups having 4 or fewer carbon atoms; more preferably methyl groups. Preferably all R¹ groups are the same as each other.

Preferred-R′ groups have the structure:

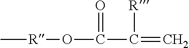

where R″ is a hydrocarbon group, preferably an alkyl group. Preferably R″ has 8 or fewer carbon atoms; more preferably 5 or fewer; more preferably 3 or fewer. Preferably R″ has 1 or more carbon atoms; more preferably 2 or more carbon atoms; more preferably 3 or more carbon atoms. R″′ is either hydrogen or methyl; preferably methyl. Preferably all R′ groups are the same as each other.

In the telechelic methacrylate functional silicone, n is preferably 10 or more; more preferably 20 or more; more preferably 50 or more; more preferably 100 or more. In the telechelic methacrylate functional, n is preferably 800 or less; more preferably 500 or less; more preferably 300 or less.

The silicone polymer may also contain polymerized units of one or more monovinyl acrylic monomer. Preferred monovinyl acrylic monomers are acrylic acid, methacrylic acid, unsubstituted-alkyl esters thereof, substituted-alkyl esters thereof, and mixtures thereof. More preferred are acrylic acid, methacrylic acid, unsubstituted-alkyl esters thereof, and mixtures thereof. More preferred are one or more unsubstituted alkyl esters of acrylic acid or methacrylic acid. More preferred are one or more unsubstituted alkyl esters of acrylic acid. Among unsubstituted alkyl esters of acrylic acid and methacrylic acid, preferred are those with alkyl group having 18 or fewer carbon atoms; more preferred is 8 or fewer carbon atoms; more preferred is 6 or fewer carbon atoms; more preferred is 4 or fewer carbon atoms. Among unsubstituted alkyl esters of acrylic acid and methacrylic acid, preferred are those with alkyl group having 2 or more carbon atoms; more preferred is 4 or more carbon atoms.

Preferably, the telechelic methacrylate functional silicone is present in the reaction mixture in an amount comprising 50 to 95 wt % of the total weight of the telechelic methacrylate functional silicone and the at least one alkyl (meth)acrylate in the reaction mixture. For example, the telechelic functional silicone is present in the reaction in an amount of at least 60 wt % or at least 70 wt %, and no more than 90 wt % or no more than 85%, of the total weight of the telechelic methacrylate functional silicone and the at least one alkyl (meth)acrylate in the reaction mixture.

The at least one alkyl (meth)acrylate preferably comprises a straight or branched C₁ to C₁₂ alkyl group. Preferred alkyl groups include methyl, ethyl, propyl, butyl, hexyl, 2-ethylhexyl, and octyl groups. Preferably, the at least one alkyl (meth)acrylate comprises methyl methacrylate.

The at least one alkyl (meth)acrylate may comprise a mixture of two or more alkyl (meth)acrylates. For example, the reaction mixture may comprise methyl methacrylate and butyl acrylate.

The reaction mixture may comprise at least one additional monomer. For example, the reaction mixture may comprise at least one additional monomer selected from organo-phosphorus monomers, a styrene (e.g., styrene sulfonic acid, acrylic acid, or methacrylic acid.

Examples of organo-phosphorus monomers include:

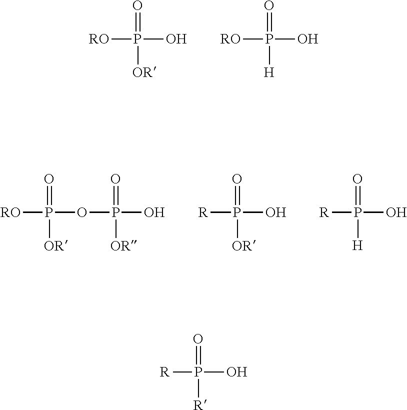

where R is an organic group containing an acryloxy, methacryloxy, or a vinyl group, and R′ and R″ are independently selected from H and a second organic group. The second organic group may be saturated or unsaturated. Suitable organo-phosphorus monomers include dihydrogen phosphate-functional monomers such as dihydrogen phosphate esters of an alcohol in which the alcohol also contains a polymerizable vinyl or olefinic group, such as allyl phosphate, mono- or diphosphate of bis(hydroxy-methyl) fumarate or itaconate, derivatives of (meth)acrylic acid esters, such as, for examples phosphates of hydroxyalkyl (meth)acrylates including 2-hydroxyethyl (meth)acrylate, 3-hydroxypropyl (meth)acrylates, and the like.

Other suitable organo-phosphorous monomers include CH₂═C(R)—C(O)—O—(R′O)ₙ—P(O)(OH)₂, where R═H or —CH₃, R′=alkyl, and n=1 to 5, such as the methacrylates SIPOMER™ PAM-100, SIPOMER™ PAM-200, SIPOMER™ PAM-400, SIPOMER™ PAM-600 and the acrylate, SIPOMER™ PAM-300, available from Solvay.

Other suitable organo-phosphorus monomers are phosphonate functional monomers, disclosed in WO 99/25780 A1, and include vinyl phosphonic acid, allyl phosphonic acid, 2-acrylamido-2-methylpropanephosphonic acid, α-phosphonostyrene, 2-methylacrylamido-2-methylpropanephosphonic acid. Further suitable organo-phosphorus monomers are 1,2-ethylenically unsaturated (hydroxy)phosphinylalkyl (meth)acrylate monomers, disclosed in U.S. Pat. No. 4,733,005, and include (hydroxy)phosphinylmethyl methacrylate.

Preferably, the organo-phosphorus monomers comprise at least one compound of formula CH₂═C(R)—C(O)—O—(R′O)ₙ—P(O)(OH)₂. More preferably, R is —CH₃, R′ is an alkyl group comprising 1 to 6 carbon atoms, and n=1.

When present, the at least one additional monomer may be present in the reaction mixture in an amount comprising 0.01 to 10 wt % based on the total weight of the at least one alkyl (meth)acrylate and the at least one additional monomer in the reaction mixture. For example, the at least one additional monomer may be present in the reaction mixture in an amount comprising at least 0.25 wt %, at least 0.5 wt %, or at least 1 wt % of the total weight of the at least one alkyl (meth)acrylate and the at least one additional compound in the reaction mixture. The at least one additional monomer may be present in the reaction mixture in an amount comprising no more than 8 wt %, no more than 6 wt %, no more than 5 wt %, or no more than 4 wt % of the total weight of the at least one alkyl (meth)acrylate and the at least one additional monomer in the reaction mixture.

The reaction may further comprise a crosslinker. The cross linker may be any polyfunctional unsaturated monomer—i.e. any monomer having two or more unsaturated groups available for addition polymerization. Examples of suitable bifunctional monomers include: ethylene glycol di(meth)acrylate, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, dipropylene glycol di(meth)acrylate, allyl (meth)acrylate, divinyl benzene and derivatives thereof. Trifunctional examples include: tripropylene glycol tri(meth)acrylate, trimethylol propane tri(meth)acrylate, pentaerythritol tri(meth)acrylate. Tetrafunctional monomers such as pentaerythritol tetra(meth)acrylate and hexafunctional monomers, e.g. dipentaerythritol hexa(meth)acrylate may also be used. Optionally, the polyfunctional monomer may comprise a mixture of more than one polyfunctional compound.

The crosslinker may be present in an amount ranging from 0.1 to 10 wt % based on the total weight of the telechelic methacrylate functional silicone and at least one alkyl (meth)acrylate.

The reaction mixture is preferably polymerized by emulsion polymerization, and more preferably, by mini-emulsion polymerization. Mini-emulsion polymerization involves the direct polymerization of latex size droplets (e.g., 100 to 500 nm droplets) using either a high pressure homogenizer or ultrasonic processor.

Preferably, the silicone acrylic impact modifier is produced in the form of a latex. As used herein, the term “latex” refers to the physical form of a polymer in which the polymer is present in the form of small polymer particles that are dispersed in water. The latex may have, for example, a mean particle size of 50 nm or greater or 100 nm or greater. The latex may have a mean particle size of 1,000 nm or less, or 800 nm or less, or 600 nm or less. The latex can be isolated into powder by coagulation or spray drying.

Preferably, most or all of the water that remains with the isolated polymer is removed from the isolated polymer by one or more of the following operations: filtration (including, for example, vacuum filtration), and/or centrifugation. The isolated polymer maybe optionally washed with water one or more times.

Preferably, the dried silicone acrylic impact modifier has a water content of less than 1.0 weight % based on the weight of the dried silicone acrylic impact modifier.

The dried silicone acrylic impact modifier may then be incorporated into a matrix resin composition containing the impact modifier and a matrix resin. After the mixture of the impact modifier and matrix resin is mixed and melted and formed into a solid item, the impact resistance of that item will be better than the same solid item made with matrix resin that has not been mixed with impact modifier. The impact modifier may be provided in a solid form, e.g., pellets or powder or a mixture thereof. The matrix resin may also be provided in solid form, e.g., pellets or powder or a mixture thereof.

Suitable matrix resins include, for example, polyolefins, polystyrene, styrene copolymers, poly(vinyl chloride), poly(vinyl acetate), acrylic polymers, polyethers, polyesters, polycarbonates, polyurethanes, and polyamides. Preferably, the matrix resin contains at least one polycarbonate. Suitable polycarbonates include, for example homopolymers of polymerized units derived from Bisphenol A (“BPA”), and also copolymers that include polymerized units of BPA along with one or more other polymerized units.

The process for preparing the silicone acrylic impact modifier of the invention may provide significant improvements in the time and complexity required to prepare silicone acrylic impact modifiers while still providing similar impact performance.

Some embodiments of the invention will now be described in detail in the following Examples.

### Examples

### Particle Size Measurement

The particle size of the oligomers were measured on a Malvern Zetasizer Nano S90 particle size analyzer.

### Comparative Example—Silicone Acrylic Impact Modifier Synthesis

A comparative example was prepared using a two-step method. Step 1: A 5 liter glass, 4-necked round bottomed flask was fitted with a mechanical stirrer, thermometer, condenser and electric heating mantel. To the reactor was charged 480.22 g of deionized water and 0.075 g of Sequestrene. The reactor contents were heated to 50° C. In a separate container, 600 g telechelic methacrylated silicone (n=62), 196 g butyl acrylate, 4 g allyl methacrylate, 18.18 g of a 23% aqueous solution of sodium dodecylbenzene sulfonate and 790 g deionized water were blended and agitated to form a monomer emulsion mixture. The monomer emulsion was then further processed into a mini-emulsion using a Misonix® ultrasonicator. This monomer mini-emulsion was added to the reactor and the reactor temperature was adjusted to 50° C. Then 20 g of t-butyl hydroperoxide 2.5% aqueous solution and 20 g sodium formaldehyde sulfoxylate 2.5% aqueous solution were added followed by 30 minute simultaneous feeds of another 20 g each of t-butyl hydroperoxide and sodium formaldehyde sulfoxylate (both 2.5% aqueous solutions) while adjusting the reactor temperature to 60° C., followed by a 30 minute hold. Step 2: A monomer emulsion was prepared in a separate container with 4 g of butyl acrylate, 196 g of methyl methacrylate, 4.55 g of a 23% aqueous solution of sodium dodecylbenzene sulfonate and 50 g of deionized water. This monomer emulsion was added to the reactor along with a 20 g of t-butyl hydroperoxide 2.5% aqueous solution and 20 g of sodium formaldehyde sulfoxylate 2.5% aqueous solution followed by 30 minute simultaneous feeds of another 20 g each of t-butyl hydroperoxide and sodium formaldehyde sulfoxylate (both 2.5% aqueous solutions) while holding the reactor temperature to 60° C., followed by a 30 minute hold. The reaction was then cooled to 40° C. and filtered. The particle size was measured to be 340 nm and the solid content was 39.6%.

### Coagulation of Comparative Example

To a 4 liter beaker was added 4.8 g of solid calcium chloride and 1162 g deionized water. The beakers contents were heated to 80° C. under agitation at 500 rpm. When the temperature reached 80° C., a preheated mixture of 442 g silicone acrylic emulsion above and 133 g deionized water at 80° C. was added slowly to the vessel, followed by a solution of 0.9 g calcium chloride dissolved in 45 g deionized water. The mixture was then heated to 95° C. and held at 95° C. for 30 minutes. After the hold, the mixture was cooled, dewatered, and washed in a Büchner funnel. The sample was washed with deionized water until the filtrate conductivity is below 30 μS/m, and then dewatered. The sample was dried into a powder in a vacuum oven.

### Inventive Example—Silicone Acrylic Impact Modifier Synthesis

An inventive example was prepared using a one-step method. A 5 liter glass, 4-necked round bottomed flask was fitted with a mechanical stirrer, thermometer, condenser and electric heating mantel. To the reactor was charged 244 g of deionized water, and 0.075 g Sequestrene. The reactor contents were heated to 80° C. In a separate container 800 g telechelic methacrylated silicone (n=62), 4 g butyl acrylate, 196.00 g methyl methacrylate, 22.73 g of a 23% aqueous solution of sodium dodecylbenzene sulfonate and 995 g deionized water were blended and agitated to form a monomer emulsion mixture. The monomer emulsion was then further processed into a mini-emulsion using a Misonix® ultrasonicator. The resulting mini-emulsion was added to the reactor and the reaction temperature was adjusted to 40° C. Simultaneous 90 minute feeds of 80.0 g t-butyl hydroperoxide 2.5% aqueous solution and 80.0 g sodium formaldehyde sulfoxylate 2.5% aqueous solution were then started. After 15 minutes the reactor temperature was adjusted to 65° C. and then after another 45 minutes to 85° C. At the end of the 90 minute feeds of t-butyl hydroperoxide and sodium formaldehyde sulfoxylate the reactor was held at 85° C. for 30 minutes and then cooled to 40° C. and filtered. The final emulsion solids content was measured to be 40.7% and the particle size was 366 nm.

### Coagulation of Inventive Example

To a 4 liter beaker was added 4.8 g solid calcium chloride and 1162 g deionized water. The beaker contents were heated to 80° C. under agitation at 500 rpm. When the contents reached 80° C., a preheated mixture of 430 g silicone acrylic emulsion above and 152 g deionized water at 80° C. was added slowly to the vessel, followed by a solution of 0.9 g calcium chloride dissolved in 45 g deionized water. The mixture was then heated to 95° C. and held at 95° C. for 30 minutes. After the hold, the mixture was cooled, dewatered, and washed in a Büchner funnel. The samples were washed with deionized water until the filtrate conductivity is below 30 μS/m, and then dewatered. The sample was dried into a powder in a vacuum oven. AFM imaging confirmed that the Comparative Example and Inventive Example had a similar morphology.

TABLE 1

| | | | | | | Final Latex | |
|---|---|---|---|---|---|---|---|
| | | Silicone Core | | | | Solids | |
| | | Silicone | BA/XL | Acrylic Shell | | Content | Particle |
| Sample | Core//Shell | (wt %) | (wt %) | MMA (wt %) | BA (wt %) | (wt %) | Size (nm) |
| Comp. | 80//20 | 75% | 25% | 98% | 2% | 39.6% | 340 |
| Ex. | | | | | | | |
| Inv. Ex. | 80//20 | 100% | 0% | 98% | 2% | 40.7% | 366 |

### Application Test Formulation

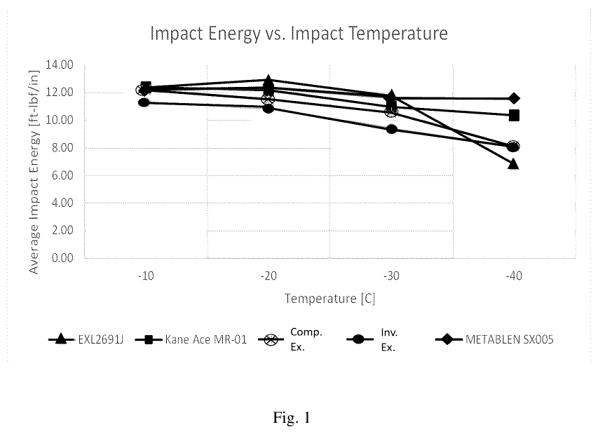

Polycarbonate resins were made by incorporating the impact modifiers produced by the method of the Comparative Example and the Inventive Example, as well as commercially available impact modifiers, including EXL2691J, a MBS CSR impact modifier, from The Dow Chemical Company; Kane Ace MR-01, a silicone impact modifier, from Kaneka; and Metablen SX005, a silicone impact modifier from Mitsubishi Chemical. The graph of FIG. 1 shows that the silicone acrylic impact modifier made by the inventive one-step process exhibited similar impact performance compared to commercially available impact modifiers.

TABLE 2

| Material | Loading level |
|---|---|
| PC LEXAN 141 | 95% |
| IMPACT MODIFIER | 5% |

Lab made Si-AIM samples at the loading level 5% were bag mixed with granulated PC pellets and other ingredients in Table 2 above, then compounded using 30 mm Werner Pfleiderer twin screw extruder with the processing conditions listed in Table 3 below.

TABLE 3

| | | | | | | | | EXTRUDER | | | | | | |
|---|---|---|---|---|---|---|---|---|---|---|---|---|---|---|
| Barrel Zone Temperatures (° C.) | | | | | | | Die | Melt | | % | Vacuum | Feeder | Pelletizer | Screw |
| 1 | 2 | 3 | 4 | 5 | 6 | 7 | (° C.) | (° C.) | RFM | Load | inHg | lb/hr | % | Type |
| 130 | 260 | 280 | 280 | 290 | 290 | 290 | 295 | 320+ | 175 | 65-75% | 20 to 25 | 24 | 80 | High |
| | | | | | | | | | | | | | | Shear |

Notched Izod impact strength was completed in accordance to ASTM D256. 5 impact bars were placed in a temperature controlled environment (23° C./50% RH) for at least 40 hours. Once sample prep was completed samples were tested at 23° C., 0° C., −20° C., and −30° C. to understand the ductile/brittle transition.

1. A one-step process for preparing a silicone impact modifier comprising:
polymerizing a reaction mixture comprising a telechelic methacrylate functional silicone and at least one alkyl (meth)acrylate.

2. The process of claim 1, wherein the telechelic methacrylate functional silicone is a compound of formula: 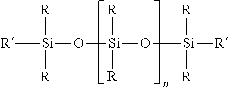
where each R is independently hydrogen or a hydrocarbon group, n is 0 to 1,000, and R′ is a group having the structure: 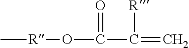
where each R″ is a hydrocarbon group and each R″′ is hydrogen or methyl.

3. The process of claim 2, wherein each R is independently hydrogen or a hydrocarbon group comprising 12 or fewer carbon atoms, and each R″ is a hydrocarbon group comprising 8 or fewer carbon atoms.

4. The process of claim 2, wherein each R is independently a hydrocarbon group comprising 4 or fewer carbon atoms.

5. The process of claim 2, wherein each R″ is a hydrocarbon group comprising 3 or fewer carbon atoms.

6. The process of claim 2, wherein each R is a methyl group, each R″ is a methyl group, and each R″′ is a methyl group.

7. The process of claim 1, wherein the telechelic methacrylate functional silicone is present in the reaction mixture in an amount comprising 50 to 95 wt % of the total weight of the telechelic methacrylate functional silicone and the at least one alkyl (meth)acrylate in the reaction mixture.

8. The process of claim 7, wherein the telechelic methacrylate functional silicone is present in the reaction mixture in an amount comprising 60 to 90 wt % of the total weight of the telechelic methacrylate functional silicone and the at least one alkyl (meth)acrylate in the reaction mixture.

9. The process of claim 1, wherein the reaction mixture further comprises at least one additional monomer selected from organo-phosphorus monomers, a styrene, acrylic acid, and methacrylic acid.

10. The process of claim 9, wherein the at least one monomer is present in the reaction mixture in an amount comprising 0.01 to 10 wt % based on the total weight of the at least one alkyl (meth)acrylate and the at least one additional monomer in the reaction mixture.

11. The process of claim 1, wherein the at least one alkyl (meth)acrylate comprises a straight or branched C₁ to C₁₂ alkyl group.

12. The process of claim 11, wherein the at least one alkyl (meth)acrylate comprises an alkyl group selected from the group consisting of methyl, ethyl, propyl, butyl, hexyl, 2-ethylhexyl, and octyl groups.

13. The process of claim 12, wherein the at least one alkyl (meth)acrylate comprises methyl methacrylate.

14. The process of claim 12, wherein the at least one alkyl (meth)acrylate comprises methyl methacrylate and butyl acrylate.

15. The process of claim 1, wherein polymerizing the reaction mixture comprises emulsion polymerizing the reaction mixture.
